(19) United States
(12) Patent Application Publication
(10) Pub. No.: US 2015/0058697 A1
(43) Pub. Date: Feb. 26, 2015

(54) STORAGE DEVICE, CONTROLLER AND MEMORY CONTROLLING METHOD

(71) Applicant: KABUSHIKI KAISHA TOSHIBA, Tokyo (JP)

(72) Inventor: Kiyotaka IWASAKI, Kanagawa (JP)

(73) Assignee: KABUSHIKI KAISHA TOSHIBA, Tokyo (JP)

(21) Appl. No.: 13/973,942

(22) Filed: Aug. 22, 2013

(51) Int. Cl. G06F 11/10

(52) U.S. Cl. CPC G06F 11/1068
USPC 714/773

(57) ABSTRACT

A nonvolatile memory device includes a plurality of memory regions, and a memory controller that controls data transfer operations to and from the memory regions. When generating an error checking and correcting code (ECC) for data including a plurality of data units and writing the data and the ECC in at least one of a plurality of memory regions, the memory controller acquires ECC information and adjusts a size of the data units and a size of the ECC on the basis of the acquired ECC information, to form a plurality of data frames each including the data unit and the ECC for the data unit.

### FIELD

Exemplary embodiments relate to a storage device, a controller, and a memory controlling method.

### BACKGROUND

A NAND type flash memory, in which data is electrically writable and erasable, has been used as nonvolatile memory for a storage device or a memory system. In the NAND type flash memory, a “page” is set as the unit of data for writing and reading. In a general flash memory, correction performance of an ECC is controlled such that a total size of data which are written and ECC given to the data is less than or equal to the size of a page.

### DESCRIPTION OF THE DRAWINGS

FIG. 1 is a diagram illustrating an overall configuration of a storage device of an exemplary embodiment.

FIG. 2 is a diagram illustrating an internal configuration of a controller of the storage device of the exemplary embodiment.

FIG. 3 is a diagram illustrating main portions of a flash memory.

FIG. 4 is an equivalent circuit diagram of a memory cell array of the flash memory.

FIG. 5 is a diagram illustrating the controller of the storage device of the exemplary embodiment.

FIGS. 6A, 6B, 6C and 6D are diagrams schematically illustrating examples of a format of data written in a storage region of the storage device of the exemplary embodiment.

FIGS. 7A and 7B are diagrams schematically illustrating examples of a format of data written in a plurality of storage regions of the storage device of the exemplary embodiment.

FIG. 8 is a diagram illustrating an operation example of the storage device of the exemplary embodiment.

FIG. 9 is a diagram illustrating an operation example of the storage device of the exemplary embodiment.

FIG. 10 is a diagram illustrating a modified example of the storage device including the controller of the exemplary embodiment.

FIG. 11 is a diagram illustrating an application example of the storage device of the exemplary embodiment.

FIG. 12 is a diagram illustrating another application example of the storage device of the exemplary embodiment.

FIG. 13 is a diagram illustrating another application example of the storage device of the exemplary embodiment.

### DETAILED DESCRIPTION

Hereinafter, with reference to the drawings, the exemplary embodiment will be described in detail. In the following description, an element having the same function and configuration is given the same reference numeral, and the description thereof is made as necessary.

In general, according to one embodiment, a nonvolatile memory device includes a plurality of memory regions, and a memory controller that controls data transfer operations to and from the memory regions. When generating an error checking and correcting code (ECC) for data including a plurality of data units and writing the data and the ECC in at least one of a plurality of memory regions, the memory controller acquires ECC information and adjusts a size of the data units and a size of the ECC on the basis of the acquired ECC information, to form a plurality of data frames each including the data unit and the ECC for the data unit.

### (1) Exemplary Embodiment

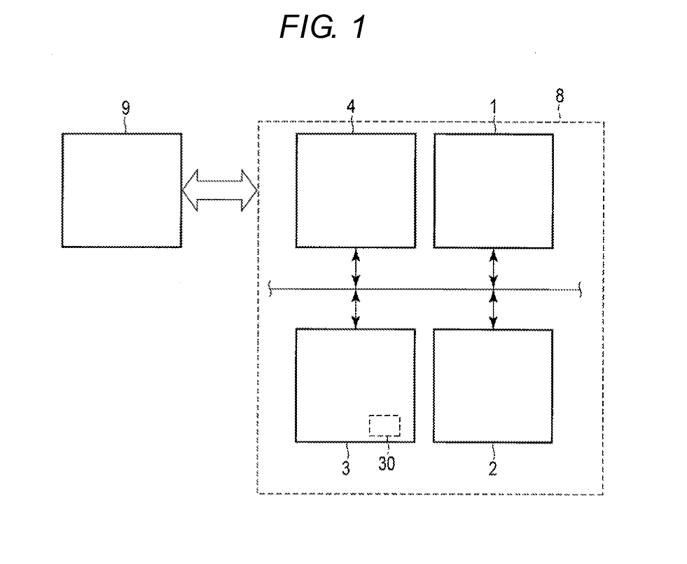

With reference to FIG. 1 to FIG. 9, a storage device of the exemplary embodiment will be described.

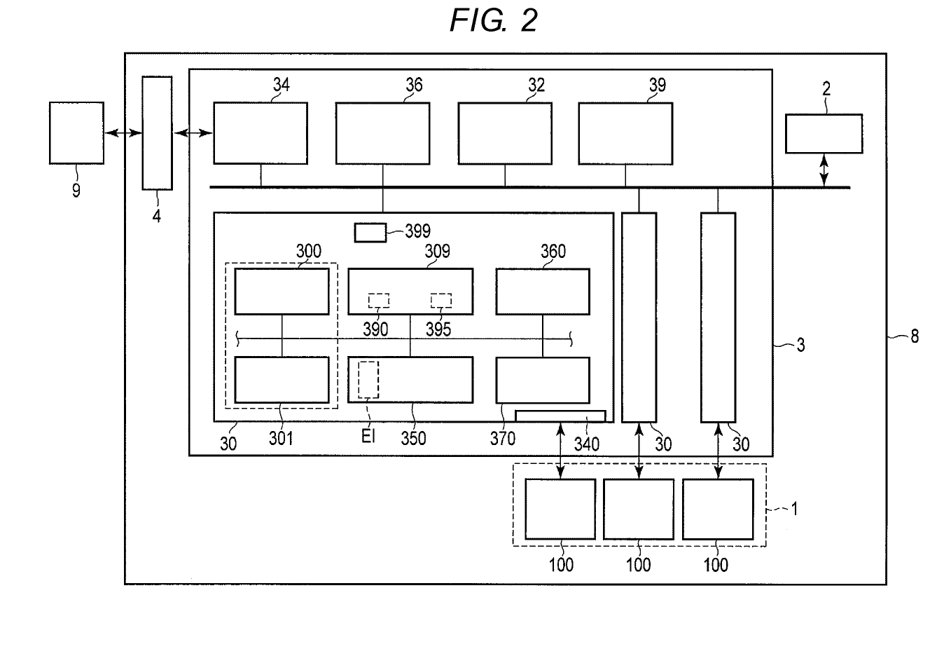

FIG. 1 is a schematic block diagram illustrating a storage device of the exemplary embodiment. FIG. 2 is a schematic block diagram illustrating an example of an internal configuration of a controller of the storage device of the exemplary embodiment.

As shown in FIG. 1, the storage device 8 of the exemplary embodiment includes a first memory 1, a second memory 2, a controller (hereinafter, also referred to as a processor) 3, an interface circuit 4, and the like. The memories 1 and 2, the controller 3, and the interface circuit 4 are connected to each other via a bus, and can transmit and receive data and signals to and from each other.

For example, the storage device 8 is a solid state drive (SSD).

The first memory 1 stores data which is transmitted from a host 9 or other devices, or data which is generated in the storage device 8. A nonvolatile memory is used as the first memory 1. For example, as shown in FIG. 2, the first memory 1 includes one or more flash memories 100.

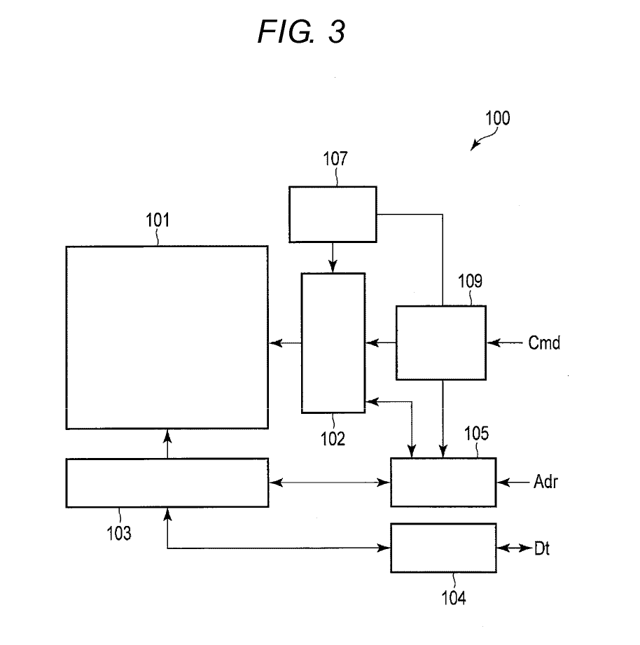

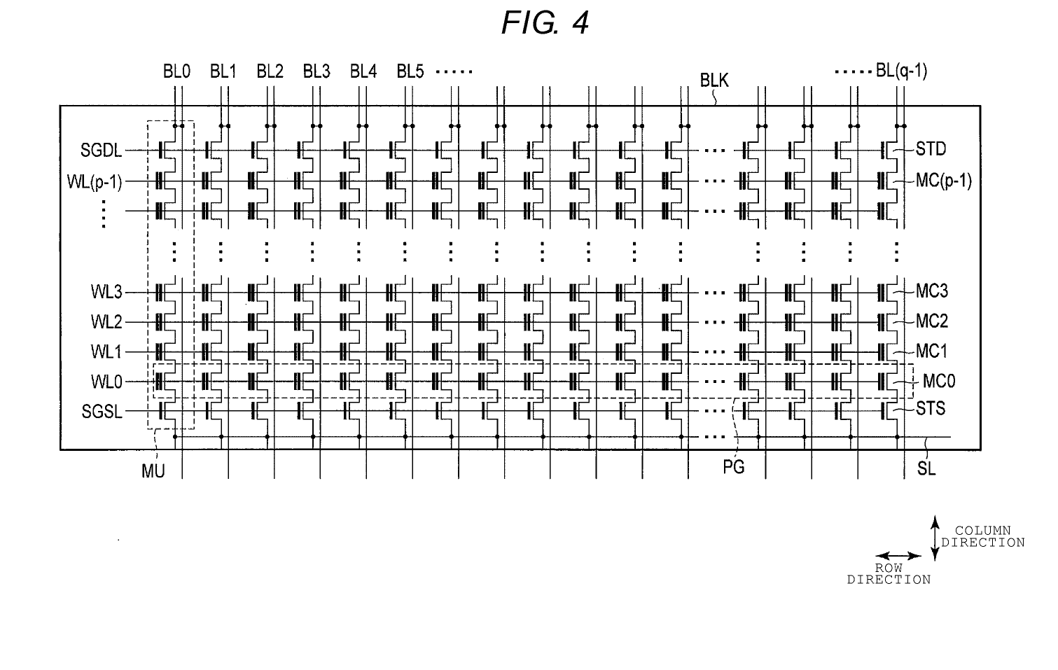

With reference to FIGS. 3 and 4, a configuration example of the flash memory 100 which is the first memory will be described.

FIG. 3 is a block diagram illustrating main portions of an internal configuration of the flash memory.

As shown in FIG. 3, the flash memory 100 includes a memory cell array 101 which stores data. The memory cell array 101 includes a plurality of memory cells.

If the flash memory 100 used for the first memory 1 is, for example, a NAND type flash memory, the memory cell array 101 includes a plurality of blocks. A block represents the minimum erasure unit.

FIG. 4 is an equivalent circuit diagram illustrating an internal configuration of the memory cell array 101. FIG. 4 shows a single block circuit configuration of the memory cell array 101 of the NAND type flash memory.

In the NAND type flash memory, a single block includes a plurality of memory cell units (hereinafter, also referred to as NAND cell units) MU arranged in a row direction. For example, q memory cell units MU are provided in a single block.

A single memory cell unit MU includes a memory cell string having a plurality of (for example, p) memory cells MC0 to MC(p−1), a first select transistor STS (hereinafter, referred to as a source side select transistor) which is connected to one end of the memory cell string, and a second select transistor STD (hereinafter, referred to as a drain side select transistor) which is connected to the other end of the memory cell string. In the memory cell string, current paths of the memory cells MC0 to MC (p−1) are connected in series in a column direction. The number of the memory cells forming a single memory cell unit MU may be two or more. Hereinafter, if the memory cells MC0 to MC(p−1) are not differentiated from each other, the memory cells are referred to as a memory cell MC or memory cells MC.

One end (source side) of the memory cell unit MU, more specifically, one end of the current path of the source side select transistor STS is connected to a source line SL. In addition, the other end (drain side) of the memory cell unit MU, that is, one end of the current path of the drain side select transistor STD is connected to a bit line BL.

The memory cell MC is a field effect transistor with a stack gate structure having a charge accumulation layer (for example, a floating gate electrode, or an insulating film including a trap level). In the two adjacent memory cells MC in the column direction, the source of one memory cell MC is connected to the drain of the other memory cell MC. Thereby, the current paths of the memory cells MC adjacent to each other are connected in series to form the memory cell string.

The drain of the source side select transistor STS is connected to the source of the memory cell MC0. The source of the source side select transistor STS is connected to the source line SL. A voltage of the source line SL is controlled by a source line control circuit (not shown).

The source of the drain side select transistor STD is connected to the drain of the memory cell MC(p−1). The drain of the drain side select transistor STD is connected to one of a plurality of bit lines BL0 to BL(q−1).

Word lines WL0 to WL(p−1) extend in the row direction, and each of the word lines WL0 to WL(p−1) is connected in common to the gates of a plurality of memory cells MC arranged in the row direction.

A drain side select gate line SGDL extends in the row direction, and is connected in common to the gates of a plurality of drain side select transistors STD arranged in the row direction. A source side select gate line SGSL extends in the row direction, and is connected in common to the gates of a plurality of source side select transistors STS arranged in the row direction.

Hereinafter, if the bit lines BL0 to BL(q−1) are not differentiated from each other, the bit lines are referred to as a bit line BL or bit lines BL, and if the word lines WL0 to WL(p−1) are not differentiated from each other, the word lines are referred to as a word line WL or word lines WL.

Each memory cell MC stores data from outside by setting a magnitude of a threshold voltage (distribution of threshold voltage) of the memory cell (transistor) MC according to the data.

Each memory cell MC stores binary (1 bit) or ternary (2 bits) or more data.

For example, if a single memory cell MC stores binary (1 bit) data “0” and “1”, the memory cell MC has two threshold distributions corresponding to the data. In addition, if a single memory cell MC stores quaternary (2 bits) data “00”, “01”, “10” and “11”, the memory cell MC has four threshold distributions corresponding to the data. Hereinafter, a memory cell which stores ternary (2 bits) or more data is referred to as a multi-value memory.

Data is collectively written in or read from the memory cells MC connected to the same word line WL. The control unit of writing or reading of data in the flash memory is called a page (or a physical page, or a physical address) PG. Data of the multi-value memory is written and read for each lower bit or for each higher bit. Therefore, if the memory cell MC holds 2-bit data, two pages are assigned to a single word line WL.

A storage capacity (data size) of the page which is a storage region is defined by the number of the memory cells MC connected to the word line WL.

A row control circuit 102 controls the rows of the memory cell array 101. The row control circuit 102 is connected to the word lines WL and the select gate lines SGDL and SGSL provided in the memory cell array 101. The row control circuit 102 includes a row decoder, a word line driver, and the like. The row control circuit 102 selects a block and a page on the basis of an address signal Adr transmitted from an address buffer 105, and controls operations (voltages) of the word lines WL and the select gate lines SGDL and SGSL.

A column control circuit 103 controls selection and potentials of the bit lines BL of the memory cell array 101, input and output of data read from the memory cell MC, input and output of data written in the memory cell MC, and the like. The column control circuit 103 includes a sense amplifier circuit, a data latch circuit, a column decoder, and the like. The sense amplifier circuit detects and amplifies a voltage variation of the bit line BL when data is read (when data is output from the memory cell array 101), and discriminates data which is stored in the memory cell MC. The sense amplifier circuit charges or discharges the bit line BL when data is written (when data is input to the memory cell array 101). The data latch circuit temporarily stores data read from the memory cell array 101 and data which is to be written in the memory cell array 101. The column decoder selects and activates a control unit which is set for a column of the memory cell array 101.

A voltage generation circuit 107 generates a writing potential, a reading potential, an erasing potential, an intermediate potential, and a non-selection potential, which are respectively applied to each word line WL when data is written (programmed), and data is read and erased. In addition, the voltage generation circuit 107 generates, for example, a voltage applied to the select gate lines SGDL and SGSL. The potentials generated by the voltage generation circuit 107 are input to the row control circuit 102 and are respectively applied to a selected word line, a non-selected word line, and the select gate lines. The voltage generation circuit 107 generates a voltage applied to the source line SL and a voltage applied to a well region.

A data input and output buffer 104 is an interface of input and output of data in the flash memory 100. The data input and output buffer 104 temporarily holds data Dt from an external device (for example, the controller, the host, or the like). The data input and output buffer 104 outputs the held data from the external device to the memory cell array 101 at a predetermined timing. The data input and output buffer 104 temporarily holds data which is output from the memory cell array 101. The data input and output buffer 104 outputs the held data Dt to an external device of the flash memory 100 at a predetermined timing.

The address buffer 105 temporarily holds an input address signal Adr. The input address signal Adr indicates a physical address, and includes a physical row address and a physical column address.

An internal control circuit (also referred to as a state machine) 109 manages an operation of the overall flash memory. The internal control circuit 109 receives a control signal (command) Cmd from an external device. The control signal Cmd is output from, for example, a controller 3 or 30 or the host 9. For example, the internal control circuit 109 includes a command interface and the like. For example, the internal control circuit 109 transmits a control signal (status) indicating internal operation circumstances of the flash memory 100 to the controller 3 or 30 (or the host). Thereby, a notification of the operation circumstances of the flash memory 100 is sent to the external controller 3 or 30 or host 9 of the flash memory 100.

The second memory 2 is, for example, a RAM. The RAM which is the second memory 2 temporarily holds a management table of the flash memory 100 which is the first memory 1, or data transmitted between the host 9 and the first memory 1. The RAM 2 which is the second memory 2 includes at least one of an SRAM, a DRAM, an MRAM, a ReRAM and a PCRAM.

An interface circuit (also referred to as a host interface circuit) 4 controls communication (data transmission) between the storage device 8 and the host 9. The interface circuit 4 includes an interface (also referred to as a host interface) which controls data transmission between the storage device 8 and the host 9 on the basis of a standard such as SAS or SATA.

The host 9 transmits (issues) various commands or requests to the storage device 8 according to an operation executed by the host 9. The host 9 transmits data which is to be written in the memory 1 to the storage device 8, or receives data which is reads from the memory 1, from the storage device 8.

The controller 3 manages and controls operations of the respective circuits 1, 2 and 4 in the storage device 8 in response to commands and requests from the host 9.

As shown in FIG. 2, in the exemplary embodiment, the controller (hereinafter, also referred to as a processor or a device controller) 3 includes the memory controllers 30, a buffer controller 32, an interface controller 34, a data buffer 36, a CPU 39, and the like.

The CPU 39 controls and manages operations of the respective circuits of the controller 3. In addition, the CPU 39 may analyze a command or a request from the host 9.

The data buffer 36 temporarily holds data from the host 9 during a period until the data is transmitted to the memory controller 30, or temporarily holds data from the memory 1 and the memory controller 30 during a period until the data is transmitted to the host 9.

The buffer controller 32 controls an operation of the data buffer 36. For example, the buffer controller 32 controls a timing when data is input to the data buffer 36 and a timing when data is output from the data buffer 36. In addition, the buffer controller 32 informs the controller 3 (and the memory controllers 30) or the interface controller 34 of operation circumstances of the data buffer 36.

The interface controller 34 manages and controls the interface circuit 4 which connects the host 9 to the storage device 8. The interface controller 34 may be provided in the interface circuit 4.

The memory controller 30 manages and controls an operation of the first memory 1. For example, a plurality of memory controllers 30 are provided in the controller 3 according to the number of a plurality of flash memories 100 included in the first memory 1. For example, one or more memory controllers 30 are provided in the controller 3 such that the flash memory 100 and the memory controller 30 correspond to each other in a one-to-one relationship. Hereinafter, if the flash memory 100 is a NAND type flash memory as in the exemplary embodiment, the memory controller 30 is also referred to as a NAND controller 30. In addition, in FIG. 2, three NAND controllers 30 and three flash memories 100 are provided, and the number of channels between the first memory 1 and the controller 3 is three; however, the number of channels is not limited thereto and may be two or less or four or more.

The NAND controller 30 controls writing, reading and erasing for the NAND type flash memory 100.

The NAND controller 30 includes a channel control circuit (also referred to as a channel controlling unit) 309. The channel control circuit 309 controls an operation of writing data from the data buffer 36 into the NAND type flash memory 100 or an operation of reading data from the NAND type flash memory 100 into the data buffer 36. The channel control circuit 309 of the NAND controller 30 includes a writing control circuit (writing controlling unit) 390 which controls writing for the flash memory 100. The NAND controller 30 includes a reading control circuit (reading controlling unit) 395 which controls reading for the flash memory 100.

Data written in the flash memory 100 or data read from the flash memory 100 is processed by the NAND controller 30 (and the channel control circuit 309) by using the data unit (also referred to as a data set or a data group) with a certain data size (data length) as a control unit. The data unit is a control unit of any data size into which data to be written and read data are divided.

The NAND controller 30 includes a circuit (also referred to as an ECC circuit or an ECC controlling unit) having a function of controlling error checking and correcting (ECC) and of executing ECC when data is written in the NAND type flash memory 100.

An ECC encoder 300 and an ECC decoder 301 are provided in the NAND controller 30 as the ECC circuit.

The ECC encoder 300 generates the error checking and correcting code (hereinafter, referred to as ECC or an ECC code) from data to be written in the NAND type flash memory 100. In addition, in generating the ECC from the data, a data frame (hereinafter, referred to as an ECC frame or a data set) is formed by combining the data (data unit) having a certain data size with the ECC (ECC unit) having a certain size. The ECC frame is one of the control units of writing or reading data including a data unit with a certain data size and an ECC for the data unit. The data unit is valid data from an external device.

If data is read from the NAND type flash memory 100, the ECC decoder 301 checks and corrects errors of the read data on the basis of an ECC generated when the data was written.

Hereinafter, decoding or encoding an ECC, generating an ECC, and the like are referred to as an ECC process or ECC processes if the processes executed by the ECC circuit are not differentiated from each other.

In the exemplary embodiment, the controller 3 and the internal NAND controller (memory controller) 30 thereof include circuits and control units performing the following functions.

The NAND controller 30 includes an ECC information management circuit (also referred to as an ECC information management unit) 350.

The ECC information management circuit 350 holds and manages one or more pieces of information (hereinafter, referred to as ECC information or memory information) EI for an ECC process performed when data is written in the NAND type flash memory 100.

The ECC information EI manages a size of the data unit extracted from data to be written, a correction performance of an ECC, a size of the data unit for which the ECC is generated, the number of ECC frames written in a single page, and various flags used for ECC when data is written or read.

This ECC information EI is provided to the channel control circuit 309 from the ECC information management circuit 350, and is acquired by the channel control circuit 309.

In the exemplary embodiment, a process in which the ECC information is provided to and acquired by the channel control circuit 309 from the ECC information management circuit 350 is not particularly limited.

For example, a table in which the kinds (specifications and characteristics) of NAND type flash memories are correlated with the kinds of data items to be written is stored in and is managed by the ECC information management circuit 350 as the ECC information. The table in the ECC information management circuit 350 is referred to by the channel control circuit 309 and the ECC information management circuit 350, on the basis of information of the flash memory 100 connected to the NAND controller 30 or the kind of data of which a notification is sent or which is transferred from the buffer controller 32 or the data buffer 36, and the ECC information EI is transmitted to the channel control circuit 309. In addition, for example, only the correction performance of an ECC and the size of an ECC frame may be managed in the table in the ECC information circuit 350, and the number of ECC frames of data to be written may be acquired through calculation by the channel control circuit 309 and the ECC information management circuit 350 from the size of a single page of the flash memory 100 connected to the controller 30. Through these processes, the channel control circuit 309 acquires the ECC information EI.

One of flags included in the ECC information is, for example, a divided frame flag (or also referred to as a divided writing flag). The divided frame flag is a flag indicating that a single ECC frame in the data to be written is divided and is written in different addresses (for example, two pages of the flash memory). For example, the divided frame flag and other flags are indicated by a 1-bit (or several-bit) signal.

The divided frame flag may be added as the ECC information EI through an advance calculation based on a page size of the flash memory, a correction performance of an ECC which the flash memory is required to have, the number of ECC frames which can be written in a single page, or the like. In addition, the divided frame flag may be set as the ECC information EI or in a flag storage region (not shown) through determination of whether or not there is a divided frame by the channel control circuit 309 (or the controller 3 or 30) comparing the size and the number of ECC frames formed by the ECC encoder 300 with a storage capacity of one page when data of a first page is transferred or written.

The NAND controller 30 includes a divided frame holding circuit (divided frame holding unit) 360.

If a single ECC frame is divided into two pages and is written, and thus a divided frame flag is set (a flag is turned on, or a flag is built), the divided frame holding circuit 360 temporarily holds (stores) a portion of the divided ECC frame. Hereinafter, an ECC frame which is a division target is referred to as a division target frame, and one portion and the other portion of the divided ECC frames are referred to as divided frames.

The NAND controller 30 includes a page boundary determination circuit (also referred to as a storage region boundary determination unit) 370.

The page boundary determination circuit 370 determines that data of one page which is the writing unit of the NAND type flash memory 100 is transferred when data is written in the NAND type flash memory 100. The page boundary determination circuit 370 counts the number of ECC frames transferred to the flash memory from the ECC encoder 300. Thereby, the transfer of data of one page is determined by the page boundary determination circuit 370.

The NAND controller 30 includes, for example, a processor 399 which controls and manages the overall internal constituent elements of the NAND controller 30. In addition, the channel control circuit 309 may control and manage the overall internal constituent elements of the NAND controller 30. Further, the NAND controller 30 includes a data region (not shown) which temporarily holds data or a signal such as a buffer or a latch. The NAND controller 30 includes a memory interface 340 which connects the controller 3 or 30 to the flash memory such that the controller 3 or 30 can communicate with the flash memory 100.

The above-described internal constituent elements 300, 301, 309, 350, 360 and 370 of the NAND controller 30 are provided in the controller 30 by using firmware, hardware (circuit), software (program), or a combination thereof.

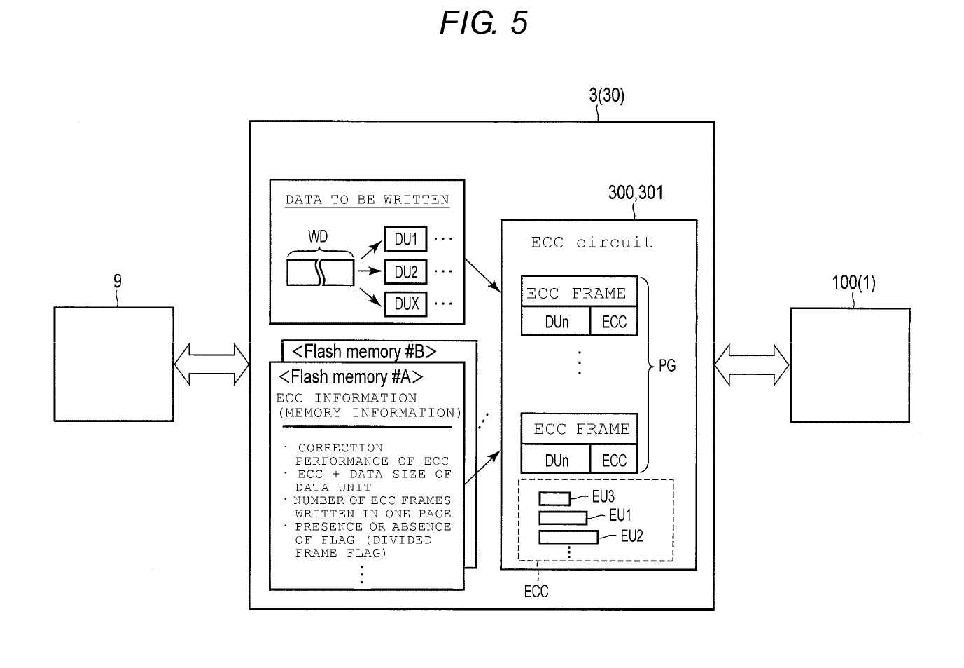

With reference to FIGS. 5 to 7B, a description will be made of functions of the controllers included in the storage device of the exemplary embodiment.

FIG. 5 is a schematic diagram illustrating a function and an operation of the controller of the storage device of the exemplary embodiment.

In the exemplary embodiment, the NAND controller 30 inquires the ECC information management circuit 350 for the ECC information EI of data to be written or read data, including one or more pieces of ECC information EI, when data is written to or read from the NAND type flash memory 100, and changes a correction performance of an ECC which has been generated for the data to be written or analyzes the ECC of the read data on the basis of the ECC information EI.

For example, the ECC information EI of the flash memory 100 stored in the controller 30 is appropriately prepared and set based on information from specifications of the different kinds of flash memories and characteristics of the flash memories, such as reliability of data stored in the flash memory 100, a correction performance of an ECC (a bit number or byte number of an ECC) the data written to the flash memory is required to have, a data size of the data unit (valid data) in an ECC frame, the number of ECC frames to be written in one page, whether or not there is a flag (for example, a divided frame flag), storage capacities (data sizes or data capacities) of a block and a page of the flash memory, and whether the flash memory is a multi-value memory or a binary memory. Hereinafter, a bit number or byte number of an ECC corresponding to the correction performance of an ECC is referred to as an ECC size.

The ECC information EI is prepared in advance for each of various kinds of flash memories through advance calculations based on the specifications, characteristics or the like for flash memories, and is provided in the controller (in the ECC information management circuit) as a database. In addition, in the exemplary embodiment, the ECC information EI may be stored in the flash memory 100, or may be transferred from an external device such as the host 9 and be stored in the RAM 2 when the storage device 8 starts an operation.

In the exemplary embodiment, the ECC encoder 300 and the ECC decoder 301 which are ECC circuits are provided in the NAND controller 30 (or the controller 3) as described above. The ECC encoder 300 and the ECC decoder 301 are formed so as to provide a plurality of different ECC patterns by using various kinds of ECC techniques such as a hamming code, cyclic redundancy check (CRC), and a parity bit, according to specifications or characteristics of the flash memories. In addition, the ECC encoder 300 and the ECC decoder 301 are formed so as to correspond to a correction performance of an ECC suitable for the flash memory 100 in the storage device 8, such as adjustment of a bit number of a hamming code or CRC, thereby providing a plurality of ECC patterns. For example, the ECC encoder 300 may generate a first ECC (an ECC unit EU1) with a certain correction performance, a second ECC (an ECC unit EU2) with a correction performance higher than the first ECC, and a third ECC (an ECC unit EU3) with a correction performance lower than the first ECC.

In addition, for example, a plurality of ECC encoders 300 having different correction performances are provided in the ECC circuit, and changing the correction performance of an ECC generated by the ECC encoder 300 or changing the size of an ECC frame are performed by changing the ECC encoder 300 to be used according to ECC information. Alternatively, a single ECC encoder 300 may be configured to have a plurality of correction performances. However, a method in which the ECC encoder 300 generates an ECC for the data is not limited to these methods.

In addition, as shown in FIG. 5, in the exemplary embodiment, the NAND controller 30 adjusts data sizes of data units DU1, DU2 and DUx that form the data WD to be written into the storage unit or data sizes of the control unit (for example, a page) of data set in the NAND type flash memory under the control of the controller 30 (or the channel control circuit 309 or the processor 390).

Hereinafter, data which is written to the flash memory 100 is referred to as data to be written, and data which is read from the flash memory 100 is referred to as read data.

In addition, data stored in a page is also referred to as page data.

For example, an ECC is generated for each data unit (a first data unit) DUn with a certain data size. Therefore, in order to protect data written in a page PG, data to be written (page data) which undergoes ECC processes includes a plurality of ECC frames including the first data unit DUn with a certain data size and an ECC having a certain correction performance corresponding thereto. In one example, data sizes of the data units DUn written in a common page PG are set to the same size.

As above, the ECC frame (or also referred to as a data frame or a data unit) includes the first data unit with a certain data size and an ECC code having a certain correction performance corresponding thereto.

The generated ECC and data unit are combined by the ECC circuit on the basis of the ECC information EI, and thus an appropriate ECC frame is formed in the flash memory.

The controller 30 of the storage device of the exemplary embodiment may adjust the number of ECC frames which are written in (assigned to) one page on the basis of adjustment of a data size of the data unit DUn and the ECC information EI such that a storage region (data size) of one page is filled with data.

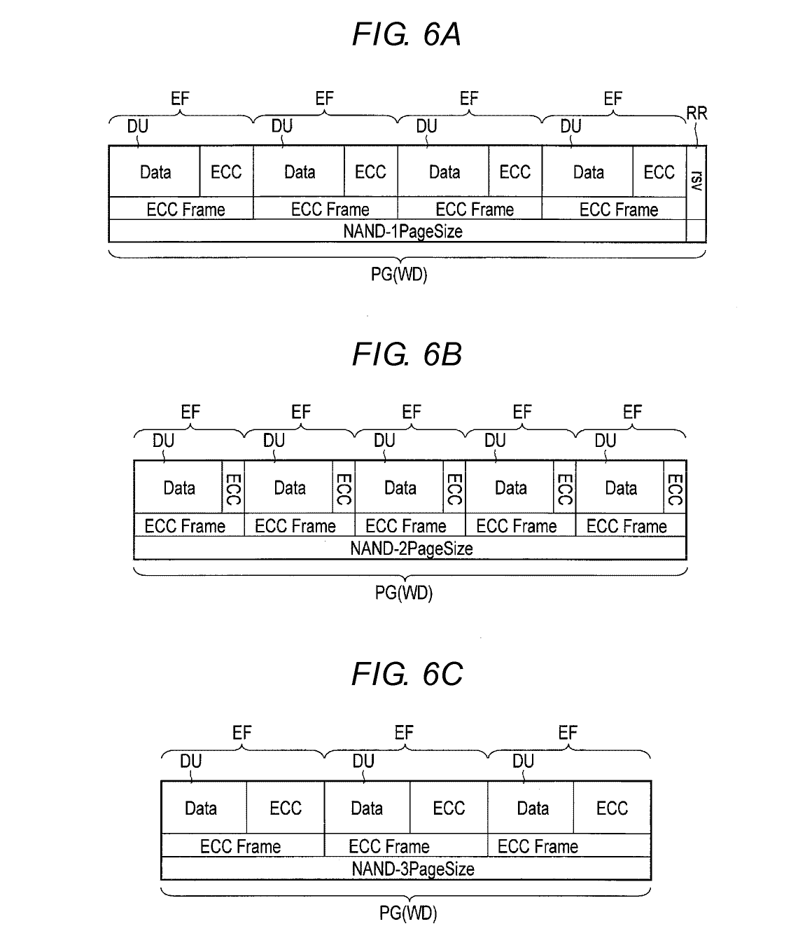

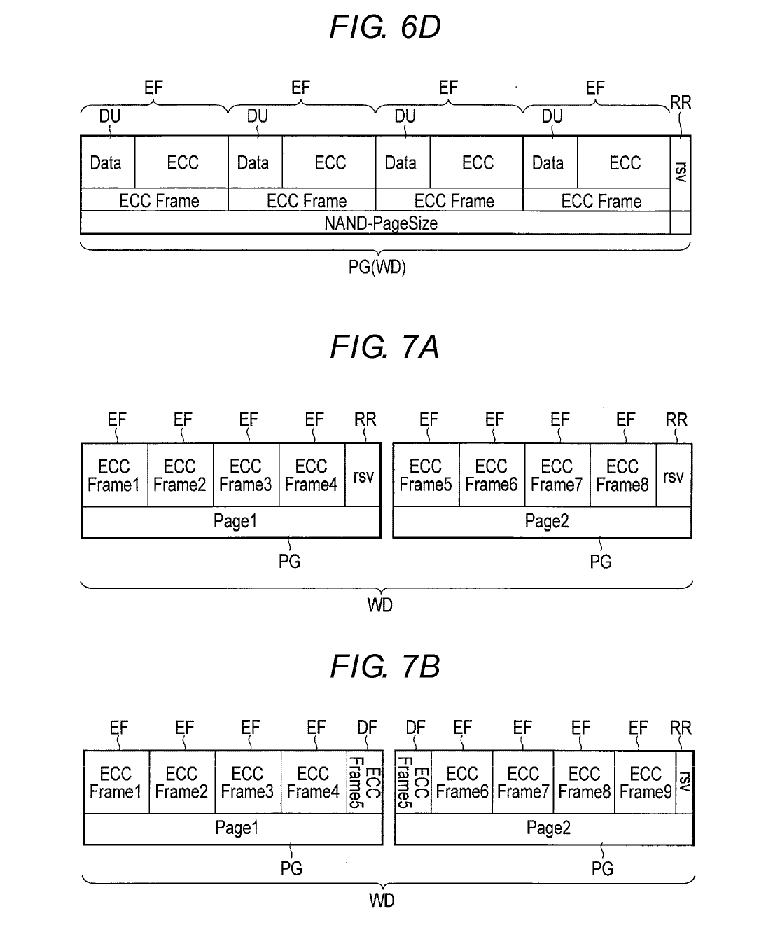

FIGS. 6A to 6D respectively show examples of a data format in a case where data with a data size corresponding to one page is written in the NAND type flash memory 100 by the controller 3 or 30 of the storage device 8 of the exemplary embodiment.

Generally, four ECC frames EF (four clusters) are set to be written in one page of the flash memory. For example, as shown in FIG. 6A, four ECC frames EF each of which includes the data unit DU with a certain data size may be written in one page PG of the NAND type flash memory 100 as data to be written WD.

For example, generally, a page of the flash memory includes a region called a reserve region. In a general flash memory, valid data is not written in the reserve region. In the exemplary embodiment, the reserve region in the page is used effectively as a storage region of data, and thus it is possible to improve use efficiency of a page and a block including a plurality of pages.

As described above, the controller of the exemplary embodiment can change a correction performance of an ECC in the ECC frame EF and a size of the first data unit. As a result, it is possible to change the number of ECC frames written in one page.

For example, if a correction performance of an ECC which the NAND type flash memory 100 of the storage device 8 is not required to be high, a size (a bit number or byte number) of an ECC can be reduced. As a result of reducing the size of an ECC, it is possible to reduce a size of an ECC frame.

Therefore, the controller 3 or 30 of the storage device 8 of the exemplary embodiment can write more than four ECC frames, for example, as shown in FIG. 6B, five ECC frames EF may be written in one page of the NAND type flash memory 100 in a flash memory with a certain specification.

As above, in the exemplary embodiment, as in the data format of FIG. 6B, in a flash memory with a certain specification, the data units or the ECC frames are written in the page PG of the flash memory 100 so as to fill the data size of one page, and, thereby, as shown in FIG. 6B, it is possible to reduce the region (reserve region) RR in which data is not written in one page, included in the data format of FIG. 6A.

Thereby, the storage device and the controllers of the exemplary embodiment can improve use efficiency of a storage region of the flash memory.

In contrast, in the exemplary embodiment, if a correction performance of an ECC of the ECC frame is to be made high according to characteristics of the NAND type flash memory 100, a size (bit number) of the ECC increases. As a result, in the flash memory 100 using an ECC with a high correction performance, a size of the ECC frame increases.

Therefore, in the flash memory 100 using an ECC with a high correction performance, the number of ECC frames written in one page becomes smaller than four. For example, as shown in FIG. 6C, three ECC frames EF are written in one page PG of the flash memory by the controller 3 or 30 of the storage device 8 of the exemplary embodiment.

As above, as in the data format of FIG. 6C, the number of data units or the ECC frames written in a page is reduced, an ECC with a high correction performance is generated, and, as a result, it is possible to improve reliability of the flash memory.

In addition, if the flash memory 100 is required to have a high correction performance of an ECC, for example, as shown in FIG. 6D, the number of ECC frames (for example, four frames) assigned to one page is not varied, but a data size of the data unit DU in the ECC frame EF is reduced to increase a bit number or a byte number of the ECC in the ECC frame EF, thereby maintaining or improving reliability of the flash memory.

As above, the controller 3 (more specifically, the memory controller 30) included in the storage device 8 of the exemplary embodiment can form data units (for example, data units with the first to fourth data sizes) with different data sizes according to specifications or characteristics (or the kinds) of flash memories, and thereby it is possible to form ECCs (for example, ECCs with the first to fourth correction performances) with different correction performances. In addition, the controller 3 of the storage device 8 of the exemplary embodiment can form an ECC frame by appropriately combining each set data size and an ECC, and can form a data format of data to be written by changing the number of ECC frames assigned to a certain page so as to fill a storage capacity of a page designated by a written address (so as to reduce a size of a reserve region as much as possible).

Further, if the controller 30 determines that an ECC is not required to be generated for a data unit on the basis of the ECC information EI in the controller 3, a frame (that is, the first data unit DU) which does not include an ECC may be written in a page.

FIGS. 7A and 7B are schematic diagrams illustrating data format examples when data of two pages is written in the flash memory.

In the controller 3 or 30 of the storage device 8 of the exemplary embodiment, as shown in FIGS. 7A and 7B, in a writing sequence of the flash memory 100, the controller 30 may write data to be written in a plurality of pages according to a data size of the data to be written transmitted from an external device.

In the data format example shown in FIG. 7A, the data to be written WD with a data size of two pages includes eight ECC frames. In addition, four ECC frames EF of the eight ECC frames EF are written in one of the two pages, and the other four ECC frames EF are written in the other of the two pages.

As in the data format example shown in FIG. 7B, the controller 30 of the exemplary embodiment can divide at least one of a plurality of ECC frames EF included in the data to be written WD into a plurality of pages so as to be written to the flash memory 100.

For example, a single ECC frame is divided into two parts which are written in two pages. In this case, a divided frame flag indicating whether or not an ECC frame EF written in the first page is divided and is written is set as ECC information through an advance calculation when the ECC information is created, and is stored in the ECC information management circuit 350 as the ECC information EI. Alternatively, the divided frame flag may be assigned to data (ECC frame) to be written during writing of data.

For example, four ECC frames EF and a portion (divided frame) DF of a division target frame are written in one of two pages PG, and the other portion DF of the division target frame and four ECC frames EF are written in the other page. Regions of pages in which divided frames are written are not limited.

In addition, two pages in which the data WD with a data size of two pages is written may be a plurality of pages in a common memory cell array or a common block of a certain NAND type flash memory 100, or may be a plurality of pages in different flash memories of a certain storage device 8.

As described above, the storage device and the controller of the exemplary embodiment adjust at least one of a correction performance of an ECC generated for data and a data size (the number of data units) written in a certain storage region on the basis of ECC information according to specifications or characteristics of the flash memories. In addition, the controllers of the exemplary embodiment and the storage device including the controllers write a plurality of data frames including the adjusted correction performance of an ECC and a data unit with the adjusted data size in a page by changing the number of data frames assigned to the page so as to fill a storage capacity of the page of the flash memory as much as possible.

In a general flash memory, a size of a data unit written in one page of the flash memory cannot be changed. In addition, in a general storage device or flash memory, since four ECC frames (clusters) are set to be written in one page of the flash memory, the number of ECC frames (the number of clusters) written in one page cannot be changed.

As a result, if a flash memory in which a correction performance of an ECC does not need to be high, is used for a storage device, there is a probability that a region (reserve region) which is not used to write data may occur in a page. In this case, use efficiency of a storage region of the flash memory is reduced, and thereby costs of the flash memory and a storage device including the flash memory increase.

In addition, there is a probability that a correction performance of an ECC for data may be insufficient depending on a specification or characteristics of a flash memory even if an entire page is used to write data. In this case, since data exceeds a storage capacity due to a generated ECC, general flash memory and controllers cannot generate an ECC with a higher correction performance to data to be written (data unit). As a result, there is a probability that reliability of data stored in the flash memory may not be secured.

As described above, the storage device and the controller of the exemplary embodiment can change a correction performance (bit number) of an ECC generated for a data unit which is written in one page of the flash memory for each page or for each ECC frame.

Therefore, according to the exemplary embodiment, it is possible to improve reliability of data stored in the flash memory which is controlled by the controller.

The storage device and the controller of the exemplary embodiment can change a data size of a data unit (a data unit in an ECC frame) written in a page of the flash memory for each page or for each ECC frame. In addition, the storage device and the controller of the exemplary embodiment can change the number of ECC frames written in one page. Thereby, it is possible to suppress a region in which data is not written in a page from occurring, and thus it is possible to write valid data over an entire page.

Therefore, according to the exemplary embodiment, it is possible to improve use efficiency of a storage region of the memory controlled by the controller.

Further, reliability of a flash memory or a size of a page is different depending on the kind of flash memory. For this reason, a control which is appropriate to control a flash memory is designed and is prepared for each flash memory so as to correspond to a specification or characteristics of the flash memory.

According to the controller of the exemplary embodiment, since a size of a data unit assigned to one page or a correction performance of an ECC can be adjusted based on ECC information (and memory information), it is possible to avoid design changes in the controller for controlling the flash memory, or a new designs of the controller.

As above, according to the exemplary embodiment, it is possible to implement a controller which can correspond to NAND type flash memories with various specifications and characteristics (performances) such as different sizes of blocks or pages or correction performances of ECCs while increasing use efficiency of a flash memory.

As described above, according to the storage device of the exemplary embodiment and the controller of the exemplary embodiment, it is possible to improve reliability and use efficiency of a memory.

(b) Operation

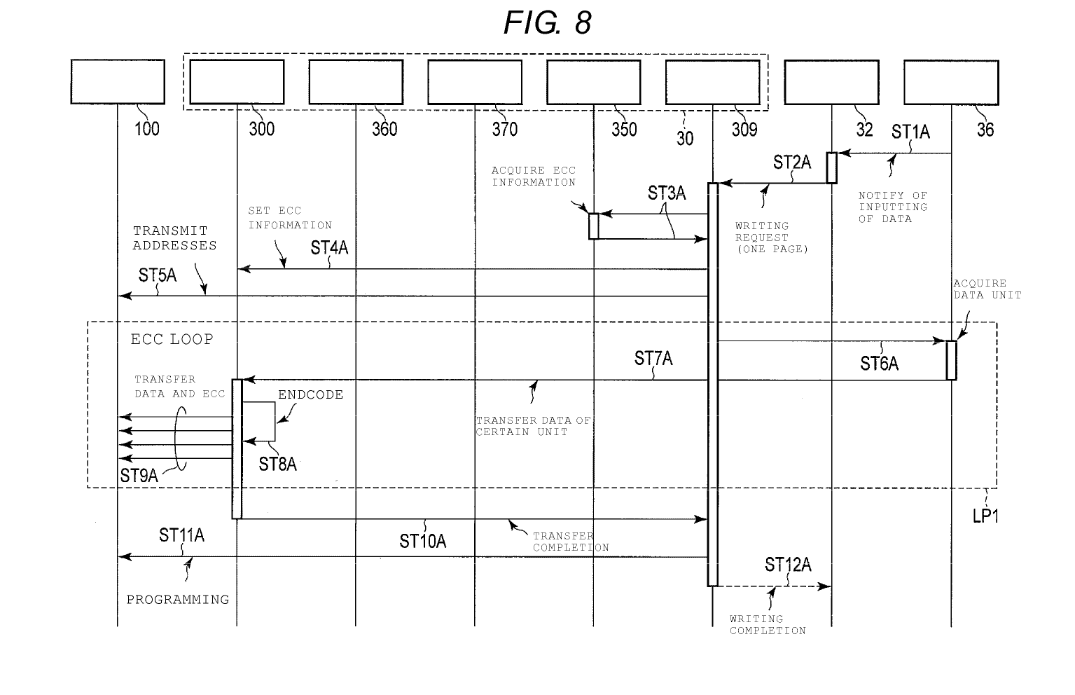

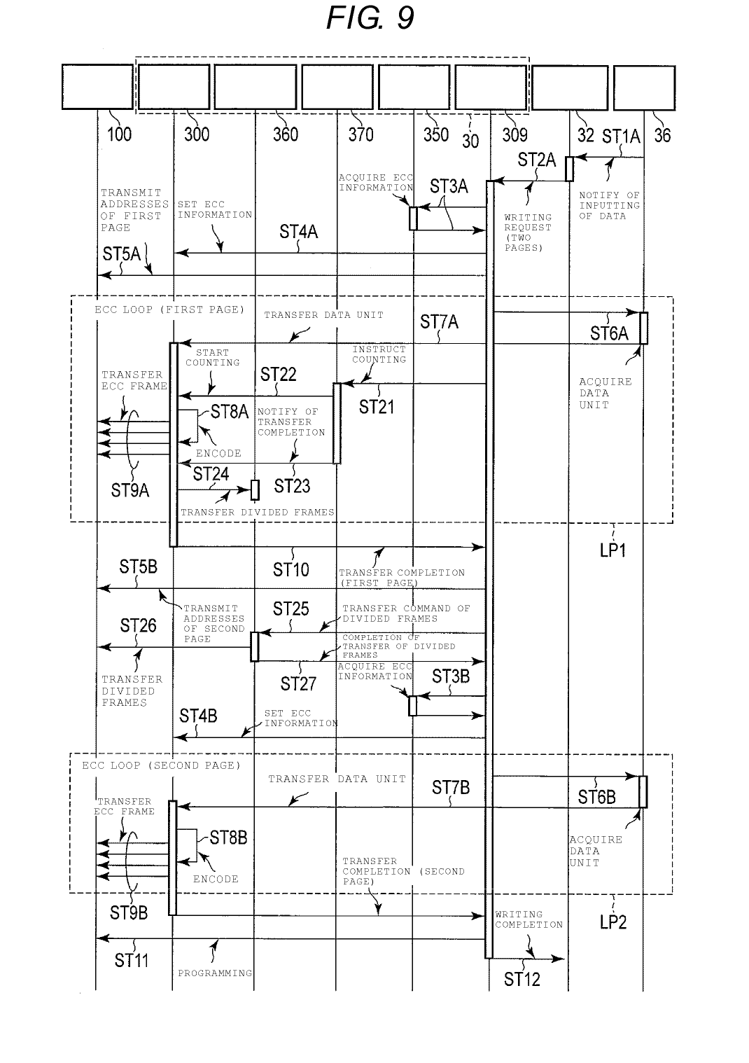

With reference to FIGS. 8 and 9, operations of the controller of the exemplary embodiment and the storage device including the controller will be described.

In addition, here, operations of the controller of the exemplary embodiment and the storage device including the controller will be described with appropriate reference to FIGS. 1 to 7B.

Writing Operation for One Page

With reference to FIG. 8, a description will be made of operations of the storage device and the controller of the exemplary embodiment when data is written in one page of the flash memory.

FIG. 8 is a sequence chart illustrating an operation when data of one page is written to the flash memory in the storage device of the exemplary embodiment.

Writing of data of one page to the memory 1 (the flash memory 100) of the storage device 8 is performed as follows under the control of the controller 3 or 30 of the storage device 8.

As shown in FIG. 8, when data is written, data to be written is transferred from the host 9 of FIG. 2 to the storage device 8. In addition, the host 9 issues a writing request to the storage device 8. Here, to issue a request (or a command) means that a control signal indicating an instruction for execution of a certain operation is transmitted from a certain device (or a circuit) to another device (or a circuit).

The data from the host 9 is input to the data buffer 36 of the storage device 8 via the interface circuit (host interface) 4. A notification that the data to be written from the host 9 is input to the data buffer 36 is sent from the data buffer 36 to the buffer controller 32 by the interface circuit 4 (or the host 9 or the controller 3) (step ST1A). In addition, the notification of inputting data to the data buffer 36 means that, for example, a control signal indicating the inputting of the data is transmitted from the data buffer 36 (or at least one of the host 9, the interface circuit 4, and the interface controller 34) to the buffer controller 32 and thereby the buffer controller 32 recognizes the inputting of the data.

A writing request is issued (transmitted) from the buffer controller 32 to the NAND controller (memory controller) 30. Here, the buffer controller 32 issues the writing request for instructing data of one page to be written, to the channel control circuit 309 of the NAND controller 30 (step ST2A).

The channel control circuit 309 inquires the ECC information management circuit 350 of the NAND controller 30 of ECC information EI of data to be written to the flash memory 100, and the ECC information EI is acquired by the channel control circuit 309 (step ST3A). The ECC information EI in the ECC information management circuit 350 includes a correction performance of an ECC (a bit number or byte number of an ECC) of the data to be written, a data size of a data unit (valid data) in an ECC frame, a size of an ECC frame, the number of ECC frames written in one page, and the like. The ECC information (also referred to as memory information) EI includes information which is set according to specifications or characteristics of the NAND type flash memories of the storage device 8. The ECC information EI for each of the flash memories 100 of which the specifications or the characteristics are different is stored in the ECC information management circuit 350, and a plurality of pieces of ECC information EI according to the specifications or the characteristics of the flash memories 100 are stored in the ECC information management circuit 350.

In the exemplary embodiment, this ECC information is provided from the ECC information management circuit 350 to the channel control circuit 309, and there are a plurality of processes in which this ECC information is acquired by the channel control circuit 309.

As an example, a table in which the kinds (specification of characteristics) of NAND type flash memories are correlated with the kinds of data items to be written is stored in the ECC information management circuit 350 and is managed by the ECC information management circuit 350.

The table in the ECC information management circuit 350 is referred to by the channel control circuit 309 and the ECC information management circuit 350 on the basis of information of the flash memory 100 connected to the NAND controller 30 or the kind of data of which a notification is sent or which is transferred from the buffer controller 32 or the data buffer 36, and the ECC information EI is transmitted to the channel control circuit 309.

In addition, as another method of providing and acquiring the ECC information, only the correction performance of an ECC and the size of an ECC frame may be managed in a table of the ECC information management circuit 350. Further, the number of ECC frames of data to be written is acquired through calculation by the channel control circuit 309 and the ECC information management circuit 350 by using the size of a single page of the flash memory 100 connected to the controller 30.

Among a plurality of pieces of ECC information EI acquired in step ST3A, for example, a notification of the correction performance of an ECC and the size of an ECC frame is sent (transmitted) from the channel control circuit 309 to the ECC encoder 300 which is an ECC circuit (step ST4A). The ECC encoder 300 generates an ECC for the data to be written (data unit) which is input in the subsequent step on the basis of the received correction performance of an ECC and the size of an ECC frame.

In addition, changing a correction performance of the ECC which is generated by the ECC encoder 300 or changing a size of an ECC frame may be performed, for example, by changing a plurality of ECC encoders 300 having different correction performances, or by forming a single ECC encoder 300 so as to correspond to a plurality of correction performances of ECCs. However, a method in which the ECC encoder 300 generates an ECC for the data is not limited to these methods.

A Write command for writing data is issued from the channel control circuit 309 to the flash memory 100 (step ST5A). In addition, the Write command in step ST5A includes a command indicating that the data is transmitted to the flash memory, and row and column addresses in the flash memory which is a writing destination.

Based on the ECC information acquired in step ST3A, data (data unit) of a predetermined size included in a single ECC frame of the data to be written inside the data buffer 36 is acquired by the channel control circuit 309 (step ST6A). In addition, the data (data unit) acquired from the data buffer 36 is transferred to the ECC encoder 300 under the control of the channel control circuit 309 (step ST7A).

The data unit transferred to the ECC encoder 300 is encoded by the ECC encoder 300 (step ST8A). In addition, an ECC generated through the encoding is combined with the data input to the ECC encoder 300. Thereby, an ECC frame with a certain data size is formed. The ECC frame includes a data unit with a certain size which is adjusted based on the ECC information acquired in step ST3A and an ECC (an error checking and correcting code with a certain bit number or byte number) with a correction performance set in the flash memory 100. The formed ECC frame is transferred to the flash memory 100 (step ST9A).

A loop LP1 of the operations from step ST6A to step ST9A is repeatedly performed by the number of times corresponding to the number of ECC frames included in the data to be written (here, data of one page) which is acquired in step ST3A. Hereinafter, operations (the operations from step ST6 to step ST9) of repeatedly forming ECC frames by the number set in data to be written (here, data of one page) with a certain size for the flash memory are referred to as an ECC loop.

The ECC frame transmitted to the flash memory 100 is stored in a temporary storage region (for example, the column control circuit 103 or the data input and output buffer 104) of the flash memory 100.

The ECC encoder 300 notifies the channel control circuit 309 of completion of the transfer of the data (here, data of one page) with the data size which is required to be written in step ST2 (step ST10A).

A Write command for instructing writing of data (programming) in the memory cells of the flash memory 100 is issued from the channel control circuit 309 to the flash memory 100. Thereby, a plurality of ECC frames corresponding to the data of one page which is temporarily stored in the column control circuit 103 (or the data input and output buffer 104) of the flash memory are written in a page (a nonvolatile storage region) of the flash memory 100, indicated by the addresses (step ST11). In addition, any method (for example, quick path write, LM writing, or the like) of writing data in the page of the flash memory 100 may be employed.

Thereby, as in the data formats shown in FIGS. 6A to 6D, and the like, the data to be written from the external device, having a data format according to a specification or characteristics (ECC information or memory information) of the flash memory, is programmed to the flash memory 100.

Subsequently, the channel control circuit 309 notifies the buffer controller 32 of completion of the writing (programming) of the required data.

In addition, in relation to a timing when the channel control circuit 309 notifies the data buffer 32 of completion of the programming, a notification of completion of writing for a predetermined page of the flash memory 100 may be sent from the flash memory 100 and then may be sent to the buffer controller 32 (or the host 9). Further, in relation to a timing when a notification of completion of the programming is sent, the notification may be sent from the channel control circuit 309 to the buffer controller 32 at a timing when transfer of data (page data) with a predetermined size to be written in the temporary storage region (the column control circuit or the input and output buffer) of the flash memory 100 is completed before a notification of completion of writing for the page of the flash memory 100 is sent. Furthermore, a notification of completion of the programming may be sent at other timings.

As described above, the size of the data unit in the ECC frame or the correction performance of the ECC, and the number of ECC frames written in one page are adjusted and changed using the ECC information according to the specification or the characteristics of the flash memory, and the data of one page is written into the flash memory.

Thereby, according to the operations (memory controlling method) of the storage device and the controller of the exemplary embodiment, reliability of the flash memory and use efficiency of a storage region are improved.

Writing Operation for Two Pages

With reference to FIG. 9, a description will be made of an operation of writing data of two pages to the flash memory.

With reference to FIG. 9, a description will be made of operations of the storage device and the controller of the exemplary embodiment when data is written in two pages of the flash memory.

FIG. 9 is a sequence chart illustrating an operation of writing data of two pages to the flash memory in the storage device of the exemplary embodiment.

Writing of data of two pages to the memory of the storage device is performed as follows under the control of the controller 3 or 30 of the exemplary embodiment of the storage device. In addition, here, a description of the substantially same operation as the writing of data (writing of data of one page) shown in FIG. 8 will be made as necessary.

As shown in FIG. 9, in the same manner as in step ST1A of FIG. 8, the buffer controller 32 is notified that data (here, data of two pages) is input to the data buffer 36.

A writing request is issued (transmitted) from the buffer controller 32 to the NAND controller (memory controller) 30 (step ST2A). Here, the buffer controller 32 issues the writing request for instructing of writing of data of two pages, to the channel control circuit 309 of the NAND controller 30.

If writing of the data of two pages is requested, ECC information EI used for data (hereinafter, referred to as data of the first page) written in one of the two pages is acquired from the ECC information management circuit 350 by the channel control circuit 309 (step ST3X).

In addition, if writing of the data of two pages is requested, the information acquired in step ST3 includes information regarding the flash memory including addresses of the first page, and ECC information such as a size of a data unit (valid data) of the first page, a correction performance of an ECC (a bit number or byte number of an ECC) of the data to be written of the first page, a size of an ECC frame of the first page, and the number of ECC frames written in one page. Further, in addition thereto, a flag (divided frame flag) is acquired which indicates whether or not there is an ECC frame (division target frame) which is divided and is written in two pages among a plurality of ECC frames written in the first page. It can be determined whether or not the divided frame flag is set (whether or not there is an ECC frame which is divided) by using a size of a page of the flash memory including the addresses of the first page or a size of an ECC frame (a data unit or an ECC).

After the ECC information and the divided frame flag are acquired in step ST3X, as shown in FIG. 9, the substantially same operations (the ECC loop LP1) as in steps ST4A to ST9A of FIG. 8 are performed.

However, if the divided frame flag is added in step ST3X when a last ECC frame is processed among a plurality of ECC frames written in the first page in the ECC loop LP1, processes in steps ST21 to ST23 of FIG. 9 are performed.

The page boundary determination circuit 370 is instructed to start counting the number of ECC frames transferred to the flash memory under the control of the channel control circuit 309 (step ST21).

The number of ECC frames transferred to the flash memory is counted by the page boundary determination circuit 370 of the controller 30 of the exemplary embodiment (step ST22).

For example, in step ST9A in which the ECC frame in the ECC loop LP1 is transferred to the flash memory 100 in the writing process of the first page, if a notification that the ECC frame is divided is sent from the page boundary determination circuit 370 to the ECC encoder 300 (or the channel control circuit 309) by using the set divided frame flag, the transfer of data from the ECC encoder 300 to the flash memory 100 is stopped in the middle of transfer of the last one ECC frame (division target frame) assigned to the page. A portion of the last ECC frame of the first page is transferred to the flash memory 100 as a divided frame.

A notification that the number of ECC frames (the number of transfers of frames) transferred to the first page of the flash memory 100 by the ECC encoder 300 reaches a data size corresponding to a storage capacity of one page of the flash memory 100 is sent from the page boundary determination circuit 370 to the ECC encoder 300 (step ST23).

The transfer of the last ECC frame of the first page to the flash memory 100 is stopped in the middle by the ECC encoder 300 on the basis of the notification from the page boundary determination circuit 370. The remaining data of the last ECC frame is transferred from the ECC encoder 300 to the divided frame holding circuit 360. The remaining data of the last ECC frame which is not transferred to the flash memory among a plurality of ECC frames stored in the first page is held by the divided frame holding circuit 360 (step ST24).

In addition, if the divided frame flag is not set, the processes in steps ST21 to ST24 are not performed, and the substantially same process as in the data writing of only one page is performed.

The channel control circuit 309 is notified of completion of the transfer of the data of one page including a plurality of ECC frames (and the divided frames) (step ST10A).

After the data of the first page is written (programmed), a writing sequence of data of the second page starts.

As shown in FIG. 9, a Write command for performing writing for the second page is issued from the channel control circuit 309 to the flash memory 100, and the flash memory is notified of addresses of the second page (step ST5B).

A channel control circuit which issues the Write command may be the same circuit as the channel control circuit which issues the Write command of the first page or may be a channel control circuit different therefrom depending on the addresses of the second page (the flash memory including the addresses) included in the Write command.

Here, the channel control circuit 309 determines that a divided frame is written in the second page on the basis of whether or not a divided frame flag indicating the presence of the divided frame is set in the ECC information or a state in which the divided frame holding circuit holds data in the data transfer (writing) of the previous page (here, the first page). If the divided frame flag indicates that the divided frame is written in the second page, the processes shown in the following steps ST25 to ST27 are performed.

An instruction (command) for writing the divided frame (the remaining portion of the last ECC frame which is not written in the first page) stored in the divided frame holding circuit 360 to the flash memory 100 is issued from the channel control circuit 309 to the divided frame holding circuit 360 (step ST25).

The divided frame of the divided frame holding circuit 360 is transferred to the flash memory 100 indicated by the addresses of the second page from the divided frame holding circuit 360 so as to be written in the addresses of the second page of the flash memory 100 (step ST26).

The divided frame holding circuit 360 notifies the channel control circuit 309 of completion of the transfer of the divided frame (step ST27).

In addition, if the ECC frame is not divided, the processes in steps ST25 to ST27 are not performed.

In addition, in the substantially same operation as the acquisition of the ECC information for data of the first page, ECC information is acquired in step ST3B in order to adjust or set a size of a data unit for data of the second page or a correction performance of an ECC and the number of ECC frames assigned to the second page. The ECC information for writing data in the second page is set in the ECC encoder 300.

Subsequently, based on the set ECC information, the substantially same operation steps ST6B to ST9B as the steps ST6A to ST9A of FIG. 8 are repeatedly performed as an ECC loop LP2 of writing data in the second page until transfer of a plurality of ECC frames forming data to be written in the second page is completed.

In addition, a timing when the divided frame is transferred to the flash memory 100 of the second page is not particularly limited to the example given herein. For example, the divided frame may be transferred before the ECC frame (data) of the second page is transferred to the flash memory 100, or may be transferred after all the ECC frames of the second page are transferred to the flash memory 100.

Subsequently, the data items of two pages including the transferred ECC frames are respectively written in the two pages (step ST11). In addition, programming of the data of the first page and programming of the data of the second page may be performed at different timings. For example, programming of the data of the first page may be performed before the addresses of the second page are transmitted (step ST5B).

Further, by repeatedly performing the substantially same operation as the operation shown in FIG. 9, the storage device including the controller of the exemplary embodiment can write data (data with a data size of three or more pages) in three or more pages of the flash memory.

As above, the size of the data unit in the ECC frame or the correction performance of the ECC is adjusted using the ECC information according to the specification or the characteristics of the flash memory, and the data of two pages is written into the flash memory. For example, a single ECC frame of data of two pages is divided and is written in different pages.

Thereby, according to the operations (memory controlling method) of the storage device and the controller of the exemplary embodiment, reliability of the flash memory and use efficiency of a storage region are improved in a writing sequence of data of two pages.

Reading Operation

Reading of data is performed as follows.

For example, reading of data is requested from an external device. The flash memory storing the requested data is accessed, and the requested data is read from one or two or more pages storing the requested data on the basis of addresses indicated by the host.

A plurality of ECC frames read from a selected page is transferred to the ECC decoder 301 and is decoded by the ECC decoder 301. Thereby, checking of whether or not there are errors in the data unit of the ECC frame and correction of errors are performed.

For example, it is determined based on presence or absence (set or reset) of a divided frame flag whether or not continuous data of two pages is requested to be read and a single ECC frame is stored over two pages. For example, a divided frame flag is checked when data of the first page is read. If the divided frame flag is set, the divided frame stored in the first page is temporarily stored in the divided frame holding circuit 360. In addition, the divided frame in the divided frame holding circuit 360 is transferred to the ECC decoder 301 when data of the second page is read. Further, the divided frame stored in the second page is transferred to the ECC decoder 301. The two divided frames are combined and undergo ECC processes by the ECC decoder 301 to form a single data unit. Furthermore, the divided frame stored in the second page may be transferred to the divided frame holding circuit along with the divided frame stored in the first page.

The data unit on which the error checking and correction is performed is transferred to the data buffer 36. In addition, if the read data with a certain data size is arranged in the data buffer 36, the data is transferred from the data buffer 36 to the host 9.

As described above, through the operations of the storage device and the controller of the exemplary embodiment, at least one of a correction performance of an ECC generated for the data and a data size (the number of data units) written in a certain storage region is adjusted based on ECC information for an ECC corresponding to specifications or characteristics of the flash memories. In addition, in the operations of the controller of the exemplary embodiment and the storage device including the controller, a plurality of data frames including the adjusted correction performance of an ECC and a data unit with the adjusted data size are written in a page by changing the number of data frames assigned to the page so as to fill a storage capacity of the page of the flash memory as much as possible.

Therefore, according to the operations (the memory controlling method) of the storage device and the controller of the exemplary embodiment, it is possible to improve use efficiency of the memory and to thereby improve reliability of data.

### (2) Modified Examples

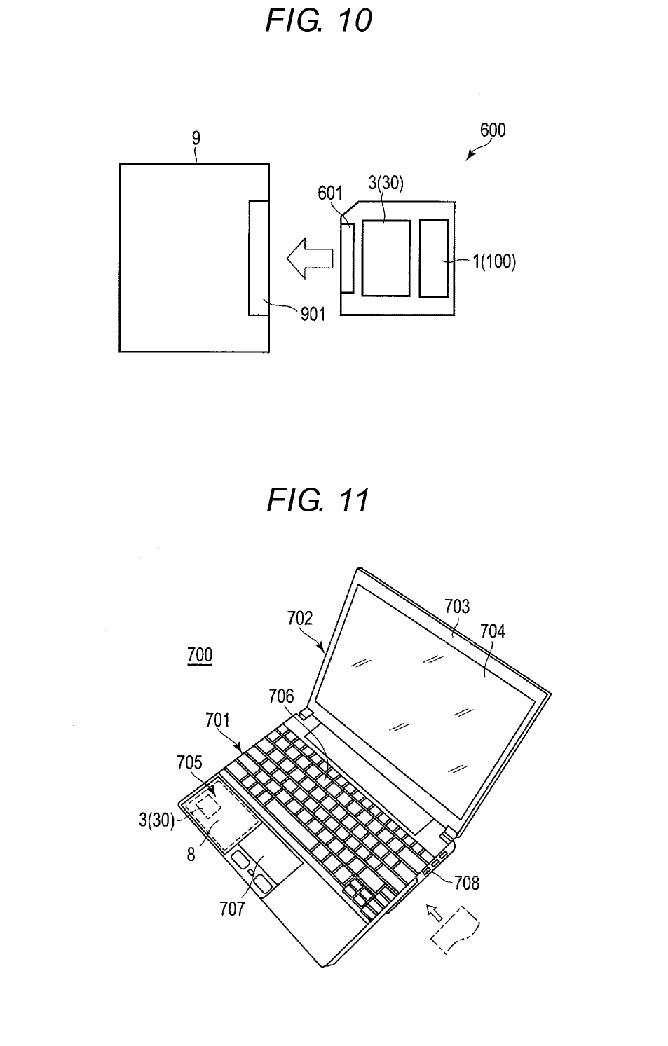

Modified examples of the storage device including the controller described in the exemplary embodiment will be described with reference to FIG. 10.

FIG. 10 is a schematic diagram illustrating one of the modified examples of the storage device including the controller described in the exemplary embodiment.

In the above-described exemplary embodiment, the SSD is exemplified as the storage device. However, the storage device may be a memory card (memory system).

As shown in FIG. 10, a memory card 600 provided with the controller 3 (30) of the exemplary embodiment includes the controller 3 (30), one or more flash memories 1 (100), and an interface 601 having a plurality of connectors. Only the memory controller (NAND controller) 30 may be provided in the memory card 600 as a controller of the memory card 600.

The memory card 600 is formed so as to be insertable into or removable from a slot 901 which is provided in the host 9 or an external device (for example, a PC, a portable terminal, or a digital camera) including the host 9. The memory card 600 including the controller 3 (30) of the exemplary embodiment is connected to the host 9 via the interface 601. In addition, the memory card 600 may be connected to the host 9 such that data communication can be performed through wireless communication (noncontact communication).

Also in a case where the controller 3 (30) of the exemplary embodiment is used for the memory card 600, as described in the exemplary embodiment, it is possible to adjust a correction performance of an ECC for data to be written or a size of a data unit in an ECC frame on the basis of ECC information of the flash memory 1 (100) mounted in the memory card 600.

Thereby, in the memory card 600 including the controller 3 (30) of the exemplary embodiment, reliability and use efficiency of a storage region are improved.

In addition, the controller 3 (30) of the exemplary embodiment may be used for a USB memory, or a storage device (memory system) based on a standard such as an embedded MultiMedia Card (eMMC) standard or a Universal Flash Storage (UFS) standard.

A description will be made of a modified example of the storage device including the controller of the exemplary embodiment, different from FIG. 10.

There are cases where the flash memory undergoes a variation in the characteristics of the flash memory due to a variation (for example, deterioration in characteristics) over time through use, and thus a correction performance of an ECC which the flash memory is required to have varies. In the storage device 8 including the controller of the exemplary embodiment, a correction performance of an ECC frame and the number of ECC frames written in a page may be changed in consideration of use years of the flash memory, the number of writing and erasing operations, the number of wear leveling operations, and the like, in addition to the ECC information. These information pieces are stored in the flash memory 100 as setting information pieces, respectively, or are provided from the host 9. These information pieces are stored in the RAM 3 as a management table of the flash memory 100 when the storage device 8 is operated.

Thereby, it is possible to use a memory of which characteristics deteriorate due to change over the years in the storage device while maintaining reliability thereof by adjusting a data size and giving an ECC with a high correction performance. Therefore, according to the controller of the exemplary embodiment, it is possible to reduce costs of a storage device.

### (3) Application Examples

Application examples of the storage device including the controller of the exemplary embodiment will be described with reference to FIGS. 11 to 13.

FIGS. 11 to 13 are schematic diagrams illustrating several application examples of the storage device (memory system) of the exemplary embodiment.

FIG. 11 is a perspective view illustrating an example of the personal computer in which the storage device (for example, an SSD) 8 of the exemplary embodiment is mounted.

As shown in FIG. 11, a personal computer 700 includes a main body 701 and a display unit 702. The display unit 702 includes a display housing 703 and a display device 704 accommodated in the display housing 703.

The main body 701 includes a casing 705, a keyboard 706, and a touch pad 707 which is a pointing device. A main circuit board, an Optical Disk Device (ODD) unit, a card slot, and the SSD 8 are accommodated in the casing 705.

The card slot is provided so as to be adjacent to a peripheral wall of the casing 705. An opening 708 opposite to the card slot is provided in the peripheral wall. A user can insert and remove an additional device into and from the card slot from outside of the casing 705 via the opening 708.

The SSD 8 may be used in a state of being mounted inside the personal computer 700 as a substituent of a hard disk drive (HDD) in the related art, or may be used as an additional device in a state of being inserted into the card slot of the personal computer 700.

The SSD 8 of the personal computer 700 includes the controller 3 (and the memory controller 30) described in the exemplary embodiment.

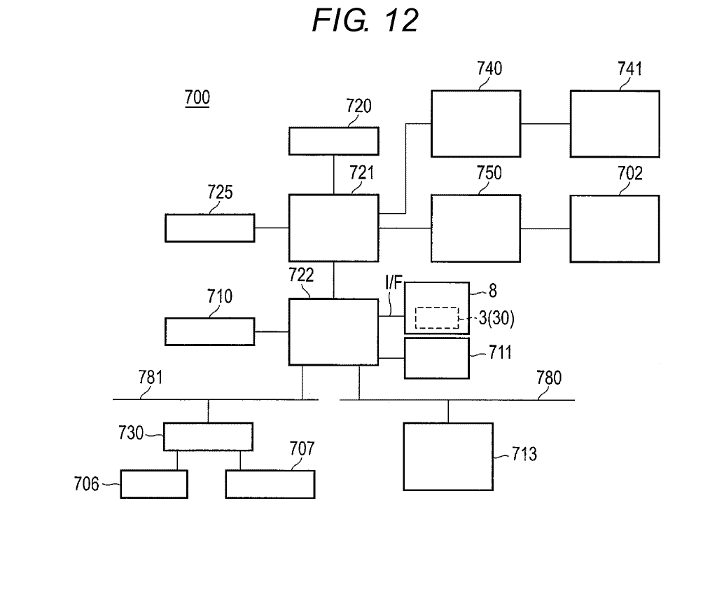

FIG. 12 is a block diagram illustrating a configuration example of the personal computer in which the SSD of the exemplary embodiment is mounted.

As shown in FIG. 12, the personal computer 700 includes a CPU 720, a northbridge 721, a main memory 725, a video controller 750, an audio controller 740, a southbridge 722, BIOS-ROM 710, the SSD 8, an ODD unit 711, an embedded controller/keyboard controller (EC/KBC) 730, a network controller 713, and the like.

The CPU 720 is a processor which is provided so as to control an operation of the personal computer 700. The CPU 720 executes an operating system (OS) loaded to the main memory 725 from the SSD 8. In addition, if the ODD unit 711 makes at least one process of a reading process and a writing process for a seated optical disc capable of being performed, the CPU 720 performs the process.

In addition, the CPU 720 also executes a Basic Input Output System (BIOS) stored in the BIOS-ROM 710. Further, the BIOS is a program for controlling hardware of the personal computer 700.

The northbridge 721 is a bridge device which connects a local bus of the CPU 720 to the southbridge 722. A memory controller which controls access to the main memory 725 is embedded in the northbridge 721.

In addition, the northbridge 721 also has a function of communicating with the video controller 750 and the audio controller 740 via an Accelerated Graphics Port (AGP) bus or the like.

The main memory 725 temporarily stores a program or data, and functions as a work area of the CPU 720. The main memory 725 includes, for example, a RAM.

The video controller 750 is a video reproduction controller which controls the display unit 702 used as a display monitor of the personal computer 700.

The audio controller 740 is an audio reproduction controller which controls a speaker 741 of the personal computer 700.

The southbridge 722 controls each device on a Low Pin Count (LPC) bus 781 and each device on a Peripheral Component Interconnect (PCI) bus 780. In addition, the southbridge 722 controls the SSD 8 which is a storage device storing a variety of software and data via an interface such as SAS or SATA.

The personal computer 700 accesses the SSD 8 with the sector unit. A write command, a read command, a cache flash command, and the like are input to the SSD 8 via the SAS interface.

In addition, the southbridge 722 also has a function of controlling access to the BIOS-ROM 710 and the ODD unit 711.

The EC/KBC 730 is a one-chip microcomputer into which an embedded controller for managing power and a keyboard controller for controlling a keyboard (KB) 706 and a touch pad 707 are integrated.

The EC/KBC 730 has a function of powering ON and OFF the personal computer 700 in response to a power button operation by a user. The network controller 713 is a communication device which communicates with an external network such as, for example, the Internet.

Configurations and operations of the SSD 8 applied to the computer and the controller 3 or 30 included therein are the same as in the above-described exemplary embodiment.

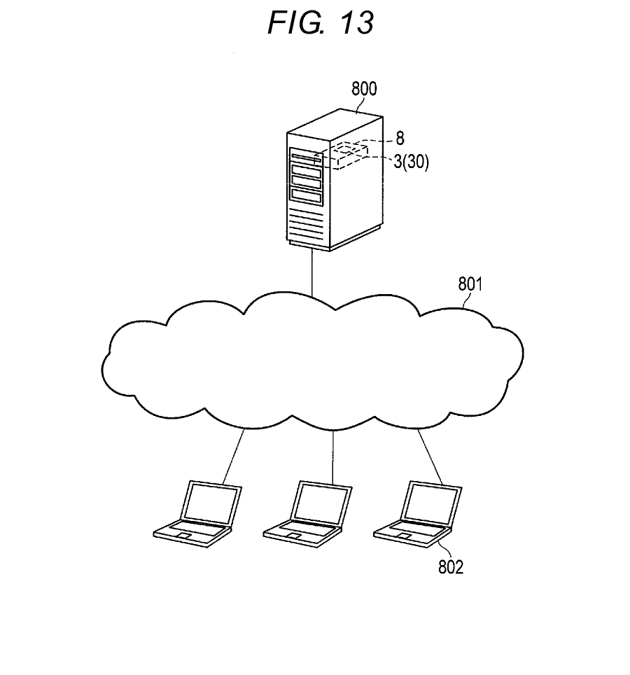

FIG. 13 is a conceptual diagram illustrating an application example of a server in which the SSD of the exemplary embodiment is mounted.

As shown in FIG. 13, a server 800 is connected to an Internet 801. The SSD 8 of the exemplary embodiment is mounted in the server 800. In addition, a terminal, for example, a computer 802 is connected to the Internet (for example, a network using cloud computing) 801. A user accesses the SSD 8 of the server 800 from the computer 802 via the Internet 801.

The SSD 8 of the server 800 includes the controller 3 (30) of the above-described exemplary embodiment.

Configurations and operations of the SSD 8 applied to the server 800 and the controller 3 or 30 included therein are the same as in the above-described exemplary embodiment.

The storage device of the exemplary embodiment and the controller included in the storage device are applied to a personal computer or a server, and thereby it is possible to improve reliability of data in the personal computer or the server and use efficiency of a storage region.

Others

Although, in the exemplary embodiment, a NAND type flash memory is exemplified as a nonvolatile memory used for the first memory, the invention is not limited thereto. Flash memories (for example, an NOR type flash memory) other than the NAND type flash memory or an MRAM, a ReRAM, or a PCRAM may be used as the first memory. In addition, the flash memory may be a flash memory (for example, a BiCS memory) with a three-dimensional structure in which a plurality of memory cells are arranged in a direction parallel to a surface of a semiconductor substrate and a plurality of memory cells are laminated in a direction perpendicular to the substrate surface.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a plurality of memory regions; and
a memory controller configured to control data transfer operations to and from the memory regions,
wherein, when generating an error checking and correcting code (ECC) for data including a plurality of data units and writing the data and the ECC in at least one of the memory regions, the memory controller acquires ECC information and adjusts a size of the data units and a size of the ECC on the basis of the acquired ECC information, to form a plurality of data frames each including the data unit and the ECC for the data unit.

2. The device according to claim 1, wherein each memory region represents a page, and the memory controller adjusts the number of the data frames formed per page on the basis of the acquired ECC information.

3. The device according to claim 2, wherein
the acquired ECC information is information set according to a specification and characteristics of the memory regions, and includes at least one of a correction performance of the error checking and correcting code, a size of the data unit, a size of the data frame, and the number of the data frames formed per page.

4. The device according to claim 1, wherein
the memory controller divides one of the data frames into first and second portions, the first portion to be written into a first memory region and the second portion to be written into a second memory region.

5. The device according to claim 1, wherein
the memory controller transfers first data frames to a first memory region for writing therein and second data frames to a second memory region for writing therein, a first portion of a divisible data frame to the first memory region for writing therein, and a second portion of the divisible data frame to a second memory region for writing therein.

6. The device according to claim 5, wherein
the memory controller divides the divisible data frame into the first and second portions during transferring of the first data frames to the first memory region.

7. The device according to claim 6, wherein
the memory controller transfers the second portion to the second memory region before the second data frames are transferred to the second memory region.

8. The device according to claim 1, wherein
when a data frame is divided and portions thereof are transferred respectively to the two memory regions, a flag indicating that the data frame has been divided is added to the ECC information.

9. The device according to claim 1, further comprising a data storage region in which the ECC information is stored.

10. The device according to claim 1, wherein
the memory regions are memory regions of a NAND type flash memory.

11. A controller for generating an error checking and correcting code (ECC) frame for data to be written into pages of nonvolatile memory, comprising:
an ECC circuit; and
a nonvolatile memory region for storing parameters based on which the ECC circuit generates ECC.

12. The controller according to claim 11, wherein the parameters include a size of data unit that undergoes processing by the ECC circuit, a size of the data frame that includes the data unit and the ECC, and the number of data frames to be written per page of nonvolatile memory.

13. The controller according to claim 12, wherein the ECC circuit adjusts a size of a data frame based on the stored parameters.

14. The controller according to claim 12, wherein the ECC circuit adjusts a size of a data frame based on the stored parameters.

15. The controller according to claim 11, wherein the parameters include a flag that indicates whether a data frame generated by the ECC circuit is divisible.

16. A memory controlling method comprising:
transmitting a request to write data including a plurality of data units in at least one memory region, to a controller;
acquiring an error checking and correcting code (ECC) information;
generating an ECC for each of the data units based on the ECC information;
forming a plurality of ECC frames, each including a data unit and the ECC generated for the data unit based on the ECC information.

17. The method according to claim 16, wherein
the ECC information is information set according to a specification and characteristics of the memory, and includes at least one of a correction performance of the ECC, a size of the data unit, a size of the ECC frame, and the number of the ECC frames written per memory region.

18. The method according to claim 16, further comprising:
dividing one of the ECC frames into a first portion and a second portion; and
writing the first portion into a first memory region and the second portion into a second memory region.

19. The method according to claim 18, wherein
the ECC frames include first ECC frames written into the first memory region and second ECC frames written into the second memory region, and
the one of the ECC frames is divided when the first ECC frames are transferred to the first memory region for writing therein, and the second portion is transferred to the second memory region for writing therein before the second ECC frames are transferred to the second memory region for writing therein.

20. The method according to claim 18, further comprising:
setting a flag in the ECC information to indicate that the one of the ECC data frames is divided.
